(19) United States
(12) Patent Application Publication
(10) Pub. No.: US 2007/0250433 A1
(43) Pub. Date: Oct. 25, 2007

(54) System and method for providing one-order methodology in over the counter markets

(76) Inventors: Harsha Bhat, Redwood City, CA (US); Kelly James Fletcher Wilson, Vancouver (CA); David Vinh Lu, Santa Clara, CA (US); Sean Michael Gilman, Rye, NY (US); Cary David Rosenwald, New York, NY (US); Richard Hartheimer, Morris Plains, NJ (US)

Correspondence Address: ANDREWS KURTH LLP;Intellectual Property Department, Suite 1100, 1350 I Street, N.W., Washington, DC, 20005, US

(21) Appl. No.: 11/410,151

(22) Filed: Apr. 25, 2006

(51) Int. Cl. G06Q 40/00

(52) U.S. Cl. 705/37

(57) ABSTRACT

A system and method provide a one-order methodology in over the counter (OTC) markets to enhance execution performance by allowing a single order to be executable in multiple liquidity pools (also referred to as exchange platforms or exchange markets). The liquidity pools typically have different credit constraints and requirements to attract different customers. A customer may have an established trading relationship and credit with multiple liquidity pools. The system and method enable the customer to place an order simultaneously in multiple liquidity pools and receive the best possible price match, also referred to as a fill. Execution certainty is therefore enhanced. The system and method also process an order faster than with traditional order routing processes.

### TECHNICAL FIELD

The technical field relates to computer-based systems for trading financial instruments, and, in particular, to a system and method for providing a one-order methodology in Over The Counter (OTC) markets.

### BACKGROUND

Financial or commodities instruments may be traded in government regulated exchanges and cleared through regulated clearing monopolies such as the National Securities Clearing Corporation (NSCC) (for equities), the Options Clearing Corporation (OCC) (for equity options), or the Government Securities Clearing Corporation (GSCC) (for treasury bonds). In contrast, instruments for which no central clearing solution exists are traded “OTC” or “Over the Counter.” OTC products are traded and settled through multiple independent venues, introducing settlement risk and therefore affecting the marketability of prices as a function of the credit worthiness of the participants. Because settlement risk varies by participant, different participants have access to different rates in an OTC market. For example, most debt instruments are traded OTC with investment banks that make markets in specific issues. If a customer wants to buy or sell a bond, he or she will contact the bank that makes a market in that bond and ask for quotes. Many instruments, including forwards, swaps, currencies, and other types of derivatives are also traded OTC. In these OTC markets, large financial institutions typically serve as dealers. i.e., market makers. In an OTC market, a fair price is typically defined by what a willing buyer will pay and what a willing seller will offer.

Following market practice, a market maker typically provides a pair of prices to its customers, i.e., bid and offer prices. The bid price is the price the market maker is willing to buy from a customer, whereas the offer price is the price the market maker is willing to sell to a customer. The bid price is typically lower than the offer price, providing a spread, i.e., profit for the market maker.

In an OTC market, a market maker may trade instruments traditionally, e.g., by phone, or electronically, e.g., using a service provider. A service provider, such as Currenex or EBS (www.ebs.com), typically provides one or more electronic communications networks (ECN), i.e., trading exchange platforms, for market participants to trade instruments electronically in an OTC market. A market maker may deal (i.e. execute trades) in multiple platforms each from a different service provider. Likewise, a service provider may support multiple market makers through multiple liquidity pools (also referred to as exchange platforms, exchanges, exchange markets).

A customer has two primary concerns when attempting to execute an order: 1) execute the best available rate, 2) execute with the highest degree of probability of execution. A customer may have a trading relationship with one or more liquidity pools. If the customers needs to buy 10 million euros versus dollars (EUR/USD) the customer could place an electronic order in multiple liquidity pools and wait for one order to fill so they cancel the others. The problem with this approach is that potentially more than one, as opposed to just one, of the liquidity pools could fill the order and as a result the customer may potentially have bought significantly more than he intended.

Alternatively, the customer could submit an order to a pool with the best perceived prices. For example, the customer may submit a single order to buy, e.g., 10 million euros, in a liquidity pool A (e.g., exchange market A) at a certain price. However, such an order may not be matched in liquidity pool A. If the customer discovers another market maker B in another liquidity pool B with a matching price, the customer must first cancel the outstanding order in liquidity pool A and resubmit the same order in liquidity pool B. However, by the time the same order is resubmitted, market maker B in liquidity pool B may have changed its price or the matching price is no longer available due to the delay, which may be, for example, as little as one tenth of a second. Therefore, neither of these two traditional approaches achieves both goals of providing the best available rate to the customer and maximizing the probability of execution. A methodology is needed to provide an exchange platform that provides both of these benefits to customers.

Many brokerage firms automatically send orders to markets with matching prices, a practice referred to as routing orders. However, with routing orders, an order must still be cancelled in the first liquidity pool before becoming executable in the second liquidity pool. Therefore, the latency problem associated with the above example also applies to routing orders.

### SUMMARY

A computer implemented method for providing a one-order methodology in over the counter (OTC) markets includes accepting orders provided by a plurality of participants that execute trade in a plurality of liquidity pools, aggregating the orders provided by the plurality of participants, accepting a first order from a first customer, and inputting the aggregated orders and the first order to a matching engine. The first order is placed simultaneously in the plurality of liquidity pools. The method further includes determining if a price match exists in one of the plurality of liquidity pools between the first order and one or more outstanding orders. The outstanding orders include orders provided by the plurality of participants. If a price match exists, the method includes determining if the first customer has an established trading relationship with the liquidity pool in which the price match exists, determining if the first customer has a sufficient credit with the liquidity pool in which the price match exists, and executing the first order if the first customer has established trading relationship and sufficient credit with the liquidity pool in which the price match exists.

A system for providing a one-order methodology in OTC markets includes a price integration layer that accepts orders from a plurality of participants and aggregates the orders provided by the plurality of participants. The system further includes a matching engine that accepts the aggregated orders from the price integration layer and accepts a first order from a first customer. The first order is placed simultaneously in a plurality of liquidity pools. The matching engine determines if a price match exists in one of the plurality of liquidity pools between the first order and outstanding orders. If a price match exists, the matching engine determines if the first customer has an established trading relationship and a sufficient credit with the liquidity pool in which the price match exists, and executes the first order if the first customer has established trading relationship and sufficient credit with the liquidity pool in which the price match exists. The system further includes a network connecting the matching engine with the price engines providing orders from a plurality of participants and a computer operated by the first customer.

A computer readable medium provides instructions for providing a one-order methodology in OTC markets. The instructions include accepting orders provided by a plurality of participants that execute trade in a plurality of liquidity pools, aggregating the orders provided by the plurality of participants, accepting a first order from a first customer, and inputting the aggregated orders and the first order to a matching engine. The customer order is placed simultaneously in the plurality of liquidity pools. The instructions further include determining if a price match exists in one of the plurality of liquidity pools between the first order and one or more outstanding orders. The outstanding orders can be provided by the plurality of participants. If a price match exists, the instructions include determining if the first customer has an established trading relationship with the liquidity pool in which the price match exists, determining if the first customer has a sufficient credit with the liquidity pool in which the price match exists, and executing the first order if the first customer has established trading relationship and sufficient credit with the liquidity pool in which the price match exists.

### DESCRIPTION OF THE DRAWINGS

Exemplary embodiments of the system and method for providing a one-order methodology in over the counter (OTC) markets will be described in detail with reference to the following figures, in which like numerals refer to like elements, and wherein:

FIG. 1 illustrates an embodiment of a system for providing a one-order methodology in OTC markets;

FIG. 2 illustrates an embodiment of a market structure established by the system of FIG. 1;

FIG. 3 is a flow chart illustrating an embodiment of a method 300 for providing a one-order methodology in OTC markets; and

FIG. 4 illustrates exemplary hardware components of a computer that may be used in connection with an exemplary method for providing a one-order methodology in OTC markets.

### DETAILED DESCRIPTION

A system and method provide a one-order methodology in over the counter (OTC) markets to enhance execution performance by allowing a single order to be executable in multiple liquidity pools (also referred to as exchange platforms or exchange markets). The liquidity pools typically have different credit constraints and requirements to attract different customers. A customer may have an established trading relationship and credit with multiple liquidity pools. The system and method enable the customer to place an order simultaneously in multiple liquidity pools and receive the best possible price match, also referred to as a fill. Execution probability is therefore increased. The system and method also process an order faster than with traditional order routing processes.

The system and method are described in the context of OTC markets for illustration purposes only. One skilled in the art will appreciate that the system and method can be applied to any asset class.

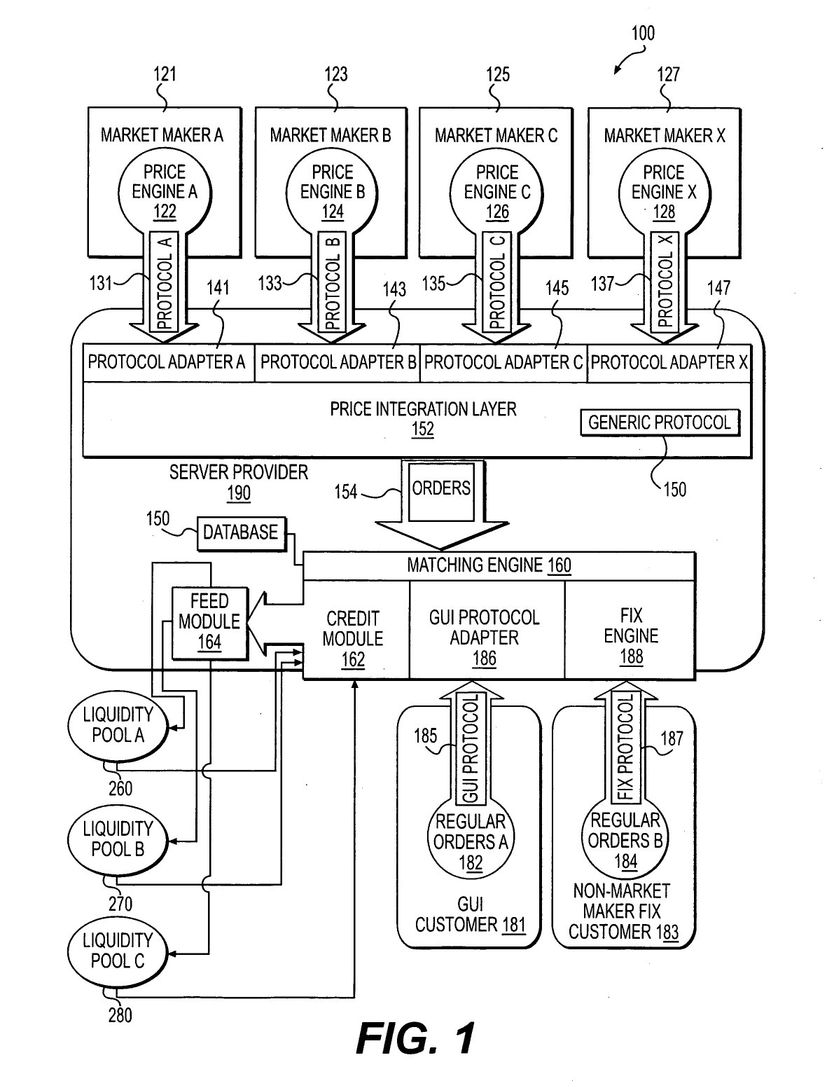

FIG. 1 illustrates an embodiment of a system 100 for providing a one-order methodology in OTC markets. As noted above, a service provider 190 typically provides one or more electronic communications networks (ECN) (also referred to as trading exchange platforms, exchange markets, or liquidity pools 260, 270, 280) for market makers 121, 123, 125, 127 to trade instruments electronically in an OTC market. The market makers 121, 123, 125, 127 typically use price engines 122, 124, 126, 128 to provide bid and offer prices, i.e., orders, electronically using various protocols 131, 133, 135, 137. The service provider 190 may have protocol adapters 141, 143, 145, 147 for each protocol 131, 133, 135, 137 to convert orders offered in a market maker's specific protocol to a generic protocol 150 in a price integration layer 152. The orders from multiple market makers 121, 123, 125, 127 may be aggregated in the price integration layer 152.

The system 100 may include a matching engine 160 that accepts bid and offer prices, i.e., orders 154, provided by different market makers 121, 123, 125, 127. The service provider 190 may operate multiple liquidity pools 260, 270, 280 through a feed module 164 and a credit module 162. Each market maker 121, 123, 125, 127 may send, via the service provider 190, different orders 154 to each liquidity pool 260, 270, 280 with which it has a trading relationship and credit.

A customer 181, 183, such as a graphic user interface (GUI) customer 181 or a non-market maker financial information exchange (FIX) customer 183, typically places a order 182, 184 into the matching engine 160 using a specific protocol, such as a GUI protocol 185 or a FIX protocol 187. The order 182, 184 (i.e., order) may be converted to a generic protocol (not shown) using, e.g., a GUI protocol adapter 186 or a FIX engine 188, respectively.

The matching engine 160 may take an order 182, 184 from a customer 181, 183 and place the order 182, 184 simultaneous in multiple liquidity pools 260, 270, 280. The matching engine 10 may attempt to match, in real-time, the order 182, 184 with other outstanding orders in one of the multiple liquidity pools 260, 270, 280. The outstanding orders may be orders 154 offered by the market makers 121, 123, 125, 127 as well as orders from customers 181, 183. Executions may occur if a price match exists in one of the liquidity pools 260, 270, 280 with which the customer 181, 183 has an established trading relationship and sufficient credit.

The customer 181, 183 may have an established trading relationship with a liquidity pool if the customer 181, 183 has an open account, a customer profile, and/or a trading transaction history with the liquidity pool. Similarly, each market maker 121. 123, 125, 127 may have an established trading relationship with each liquidity pool 260, 270, 280.

In addition, each customer 181, 183 and market maker 121, 123, 125, 127 may be assigned a credit rating by the liquidity pool based on a trading transaction. The credit rating may be updated after each additional trade. Alternatively, individual ratings following each trade may be aggregated to form an overall credit rating for each involved customer 181, 183 and market maker 121, 123, 125, 127. For example, a credit rating of, e.g., five, means average, whereas a credit rating of nine means very good. A liquidity pool may, for example, set a threshold credit rating to be six so that only customers with a credit rating of six or above can trade in the liquidity pool. The credit and trading information may be transmitted to the credit module 162 in the matching engine 160 and may be stored in a database 150 in the service provider 190.

The state of each order 182, 184 is well defined at all times. In other words, before execution, the order 182, 184 is valid and executable for all liquidity pools 260, 270, 280 with which the customer 181, 183 has sufficient credit. However, once an order 182, 184 is fully executed, the order no longer exists. Therefore, it is impossible to have an order 182, 184 executed twice even though the order 182, 184 may be present in multiple liquidity pools 260, 270, 280.

The matching engine further checks if either or both of the orders enable partial fills. If both orders have a flag enabling partial fills, a trade will be executed using the lesser amount of the two orders. If the partial fill flag is disabled in one order (order A), the trade will fail if the amount offered in order A is greater than the amount in the other order (order B). If both orders (orders A and B) have the partial fill flag disabled, the amount offered in each order need to be identical or the trade will fail.

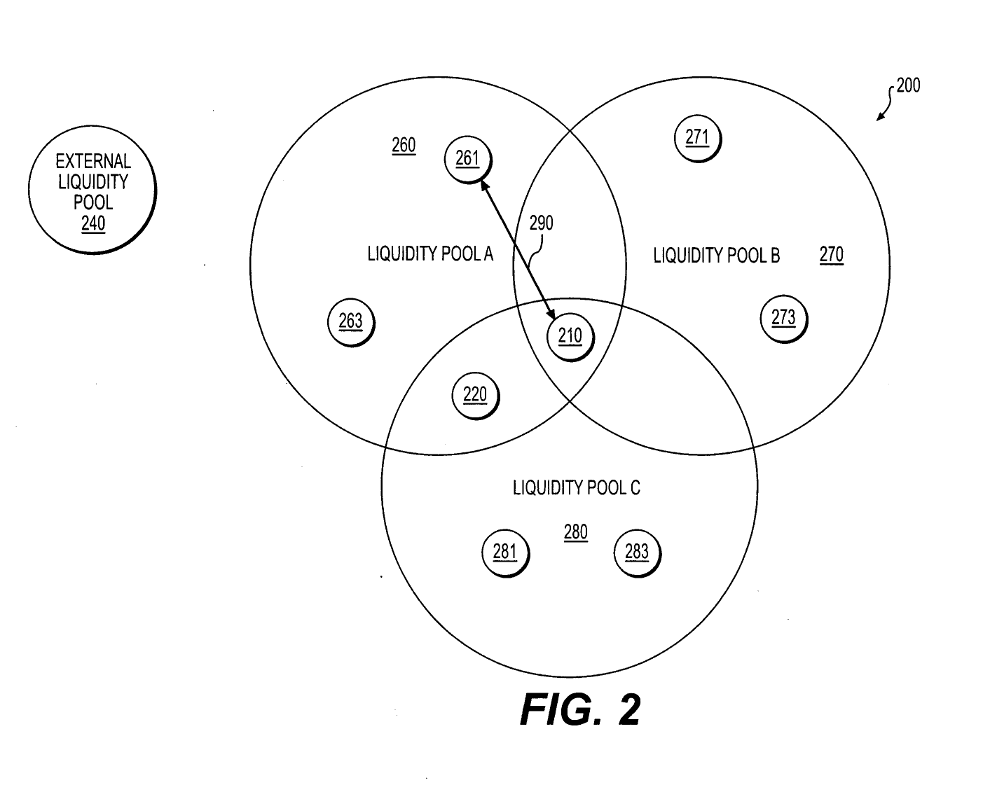

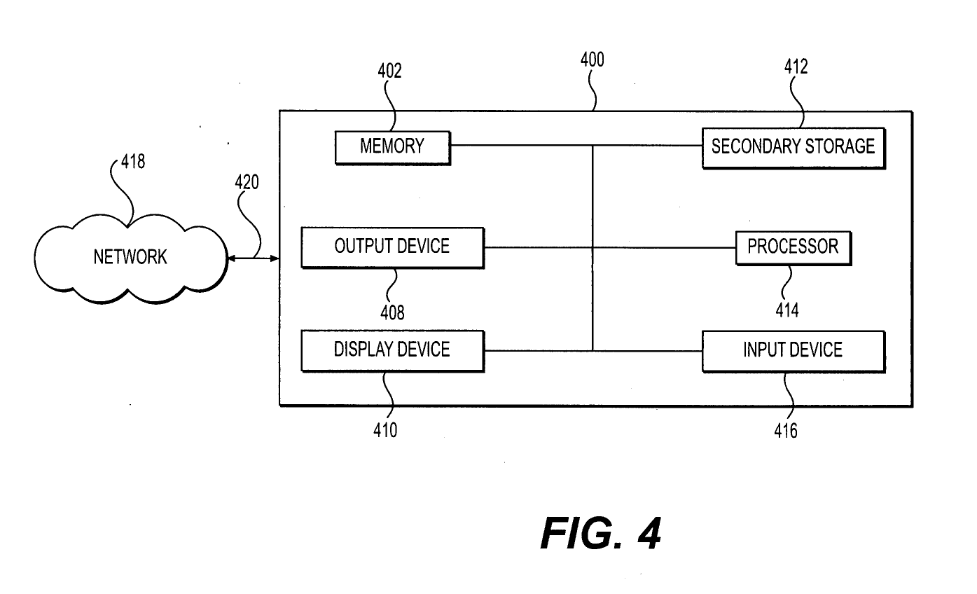

The matching engine 160 may optionally access an external liquidity pool 240 (shown in FIG. 2) to fill orders that cannot be executed in internal liquidity pools 260, 270, 280. These external liquidity pools 240 are not directly operated by the service provider 190. The matching engine 160 can be connected, through a network 418 (shown in FIG. 4), e.g., the Internet, to remote computers operated by multiple OTC market makers 121, 123, 125, 127 and the customers 181, 183.

FIG. 2 illustrates an embodiment of a market structure 200 established by the system 100. As noted above, the server provider 190 may operate multiple liquidity pools 260, 270, 280 within the same system 100 on behalf of multiple and potentially competing interests. For example, both liquidity pool A 260 and liquidity pool B 270 are trading currencies and are therefore competitors. The liquidity pools 260, 270, 280 may have different credit environments and trading processes to attract different customers 181, 183 and market makers 121, 123, 125, 127.

The customers 181, 183 and market makers 121, 123, 125, 127 may access the system 100 through the service provider's network, such as the network 418 (shown in FIG. 4). In order to trade in the liquidity pools 260, 270, 280, a customer 181, 183 and a market maker 121, 123, 125, 127 may first establish a trading relationship and sufficient credit with these liquidity pools 260, 270, 280.

After a customer 181, 183 places an order 182, 184 with the system 100, the matching engine 160 may first determine if a price match exists between the order 182, 184 and other outstanding orders 154 provided by market makers 121, 123, 125, 127. A single order 182, 184 may exist simultaneously in each of appropriate liquidity pools 260, 270, 280 with which the customer 181, 183 (i.e., order owner) has an established trading relationship and sufficient credit.

In the example shown in FIG. 2, an order 210 has access to three liquidity pools 260, 270, 280, whereas another order 220 has access to only two liquidity pools 260, 280 due to the credit constraint of the order owner. The rest of the orders, 261 and 263, 271 and 273, and 281 and 283, can each only access a single liquidity pool, either 260, 270, 280. In this example, the matching engine 160 determines that the order 210, which has access to three liquidity pools 260, 270, 280, matches (shown with arrow 290) another order 261 in liquidity pool A 260. A trade of the order 210 may be executed and sent to liquidity pool A 260 for settlement.

The service provider 190 may also access one or more external liquidity pools 240 to enhance the liquidity available to customers 181, 183. These external liquidity pools 240 are not directly operated by the service provider 190, but their price streams may be injected into the matching engine 160 in a conventional manner. If a match exists between an order and an external price stream (not shown), the order may be marked as pending and temporarily suspended from the internal liquidity pools 260, 270, 280. At the same time, an execution request may be sent to the external liquidity pool 240. If the order execution is successful, the order may be completed according to the normal order routing process. Otherwise, the order may be returned to its initial unexecuted state.

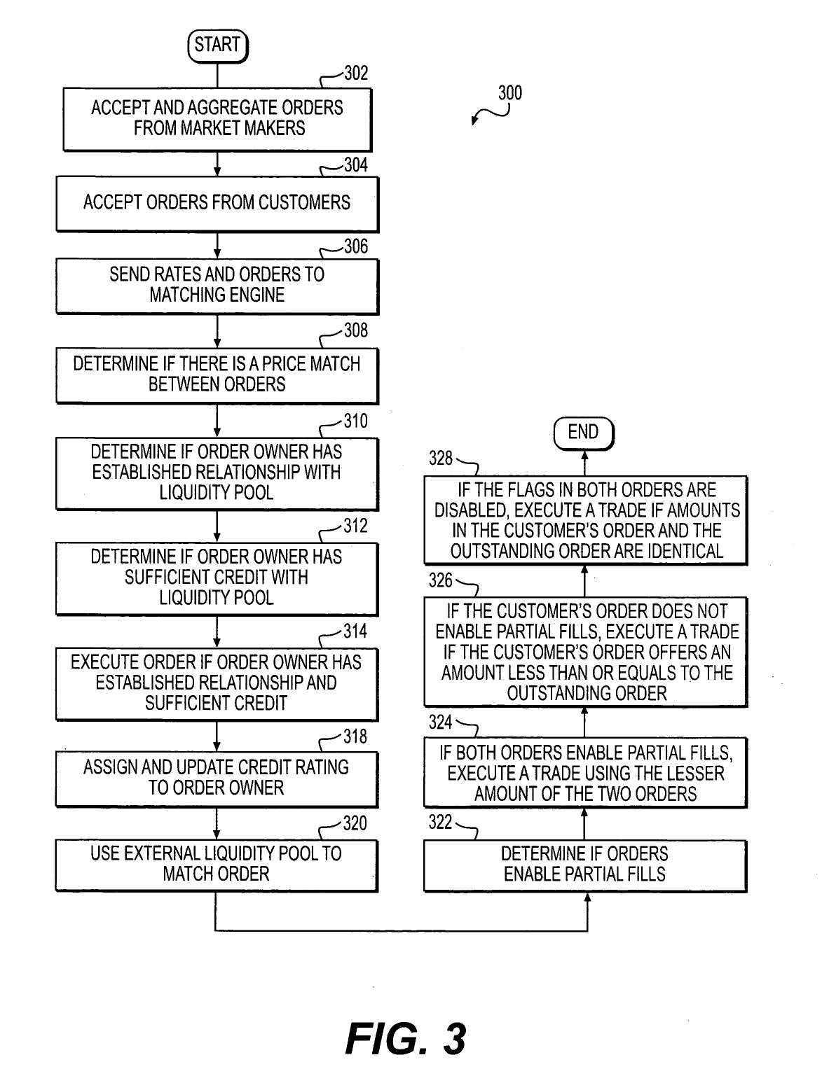

FIG. 3 is a flow chart illustrating an embodiment of a method 300 for providing a one-order methodology in OTC markets. The method 300 accepts and aggregate orders from market makers (block 302) and accepts an order from a customer (block 304). The method 300 then sends the aggregated order and the customer's order to the matching engine (block 306). Next, the matching engine determines if a price match exists, in one or more liquidity pools, between the customer's order and other outstanding orders (block 308). The matching engine then determines if the order owner for each order 182, 184 has an established trading relationship and sufficient credit with the particular liquidity pool (e.g., 260) in which a price match exists (blocks 310, 312). The matching engine executes the order if the order owner has an established trading relationship and sufficient credit with the particular liquidity pool (block 314). The liquidity pool assigns and updates a credit rating for the order owner based on the trading transaction (block 318). The matching engine may optionally use an external liquidity pool to match an order placed by a customer (block 320). The matching engine may determine if the customer's order and one of the outstanding orders enable partial fills (block 322). If, for example, both orders have a flag enabling partial fills, a trade will be executed using the lesser amount of the two orders (block 324). If the flag enabling partial fills is disabled in the customer's order, the matching engine may execute a trade if the customer's order offers an amount less than or equals to the outstanding order (block 326). If the flags in both orders are disabled, a trade may be executed if amounts in the customer's order and the outstanding order are identical (block 328).

FIG. 4 illustrates exemplary hardware components of a computer 400 that may be used in connection with the method for providing a one-order methodology in OTC markets. The computer 400 includes a connection 420 with a network 418 such as the Internet or other type of computer or telephone network. For example, the network 418 connects the matching engine 160 with the price engines 122, 124, 126, 128 from different market makers 121, 123, 125, 127. The computer 400 typically includes a memory 402, a secondary storage device 412, a processor 414, an input device 416, a display device 410, and an output device 408.

The memory 402 may include random access memory (RAM) or similar types of memory. The secondary storage device 412 may include a hard disk drive, floppy disk drive, CD-ROM drive, or other types of non-volatile data storage, and may correspond with various databases or other resources. The processor 414 may execute instructions to perform the method steps described herein. These instructions may be stored in the memory 402, the secondary storage 412, or received from the Internet or other network 418. The input device 416 may include any device for entering data into the computer 400, such as a keyboard, keypad, cursor-control device, touch-screen (possibly with a stylus), or microphone. The display device 410 may include any type of device for presenting visual image, such as, for example, a computer monitor, flat-screen display, or display panel. The output device 408 may include any type of device for presenting data in hard copy format, such as a printer, and other types of output devices including speakers or any device for providing data in audio form. The computer 400 can possibly include multiple input devices, output devices, and display devices.

Although the computer 400 is depicted with various components, one skilled in the art will appreciate that the computer 400 can contain additional or different components. In addition, although aspects of an implementation consistent with the method for providing a one-order methodology in OTC markets are described as being stored in memory, one skilled in the art will appreciate that these aspects can also be stored on or read from other types of computer program products or computer-readable media, such as secondary storage devices, including hard disks, floppy disks, or CD-ROM; a signal embodied in a carrier wave from the Internet or other network; or other forms of RAM or ROM. The computer-readable media may include instructions for controlling the computer 400 to perform a particular method.

While the system and method for providing a one-order methodology in OTC markets have been described in connection with an exemplary embodiment, those skilled in the art will understand that many modifications in light of these teachings are possible, and this application is intended to cover variations thereof.

What is claimed is:

1. A computer implemented method for providing a one-order methodology in over the counter (OTC) markets, comprising:
accepting orders provided by a plurality of participants that execute trade in a plurality of liquidity pools;
aggregating the orders provided by the plurality of participants;
accepting a first order from a first customer;
inputting the aggregated orders and the first order to a matching engine, wherein the first order is placed simultaneously in the plurality of liquidity pools;
determining if a price match exists in one of the plurality of liquidity pools between the first order and one or more outstanding orders, the outstanding orders being provided by the plurality of participants; and
if a price match exists:
determining if the first customer has an established trading relationship with the liquidity pool in which the price match exists;
determining if the first customer has a sufficient credit with the liquidity pool in which the price match exists; and
executing the first order if the first customer has established trading relationship and sufficient credit with the liquidity pool in which the price match exists.

2. The method of claim 1, wherein the outstanding orders include a second order placed by a second customer.

3. The method of claim 2, further comprising:
determining if the second customer has an established trading relationship with the liquidity pool in which the price match exists; and
determining if the second customer has a sufficient credit with the liquidity pool in which the price match exists.

4. The method of claim 1, further comprising assigning and updating a credit rating for the first customer in the liquidity pool in which the first order is executed.

5. The method of claim 1, further comprising determining if a price match exists in an external liquidity pool between the first order and outstanding orders in the external liquidity pool.

6. The method of claim 1, further comprising converting the first order provided in a customer specific protocol to a generic protocol.

7. The method of claim 1, further comprising:
determining if the first order and one of the outstanding orders enable partial fills;
if the first order and the outstanding order each has a flag enabling partial fills, executing a trade using a lesser amount of the first order and the outstanding order;
if the flag enabling partial fills is disabled in the first order, executing a trade if the first order offers an amount less than or equals to the outstanding order; and
if the flags in both the first order and the outstanding order are disabled, executing a trade if amounts in the first order and the outstanding order are identical.

8. A system for providing a one-order methodology in over the counter (OTC) markets, comprising:
a price integration layer that accepts orders from a plurality of participants and aggregates the orders provided by the plurality of participants, the plurality of participants executing trade in a plurality of liquidity pools;
a matching engine that accepts the aggregated orders from the price integration layer and accepts a first order from a first customer, wherein the first order is placed simultaneously in the plurality of liquidity pools, wherein the matching engine determines if a price match exists in one of the plurality of liquidity pools between the first order and outstanding orders, if a price match exists, determines if the first customer has an established trading relationship and a sufficient credit with the liquidity pool in which the price match exists, and executes the first order if the first customer has established trading relationship and sufficient credit with the liquidity pool in which the price match exists; and
a network connecting the matching engine with the price engines and a computer operated by the first customer.

9. The system of claim 8, wherein the outstanding orders can be provided by the plurality of participants.

10. The system of claim 8, further comprising an external liquidity pool connected to the matching engine, wherein the matching engine accesses the external liquidity pool to determine if a price match exists between the first order and outstanding orders in the external liquidity pool.

11. The system of claim 8, wherein the outstanding orders include a second order placed by a second customer.

12. The system of claim 11, wherein the matching engine determines if the second customer has an established trading relationship and a sufficient credit with the liquidity pool in which the price match exists.

13. The system of claim 8, wherein the plurality of participants include a plurality of market makers and a plurality of customers.

14. A computer readable medium providing instructions for providing a one-order methodology in over the counter (OTC) markets, the instructions comprising:
accepting orders provided by a plurality of participants that execute trade in a plurality of liquidity pools;
aggregating the orders provided by the plurality of participants;
accepting a first order from a first customer;
inputting the aggregated orders and the first order to a matching engine, wherein the first order is placed simultaneously in the plurality of liquidity pools;
determining if a price match exists in one of the plurality of liquidity pools between the first order and one or more outstanding orders, the outstanding orders being provided by the plurality of participants; and
if a price match exists:
determining if the first customer has an established trading relationship with the liquidity pool in which the price match exists;
determining if the first customer has a sufficient credit with the liquidity pool in which the price match exists; and
executing the first order if the first customer has established trading relationship and sufficient credit with the liquidity pool in which the price match exists.

15. The computer readable medium of claim 14, wherein the outstanding orders include a second order placed by a second customer.

16. The computer readable medium of claim 15, further comprising instructions for:
determining if the second customer has an established trading relationship with the liquidity pool in which the price match exists; and
determining if the second customer has a sufficient credit with the liquidity pool in which the price match exists.

17. The computer readable medium of claim 14, further comprising instructions for assigning and updating a credit rating for the first customer in the liquidity pool in which the first order is executed.

18. The computer readable medium of claim 14, further comprising instructions for determining if a price match exists in an external liquidity pool between the first order and outstanding orders in the external liquidity pool.

19. The computer readable medium of claim 14, further comprising instructions for converting the first order provided in a customer specific protocol to a generic protocol.

20. The computer readable medium of claim 14, wherein the plurality of participants include a plurality of market makers and a plurality of customers.
